(19) United States
(12) Patent Application Publication
(10) Pub. No.: US 2001/0001751 A1
(43) Pub. Date: May 24, 2001

(54) TERMINAL CONNECTION COMPRISING A U-SHAPED SPRING

(76) Inventors: HARALD MICHAEL LUTSCH, ROSSTAL (DE); HANS-OTTO GELTSCH, ROHR/REGELSBACH (DE); JOSEF KOINER, POMMELSBRUNN (DE)

Correspondence Address: CLARENCE A GREEN, PERMAN & GREEN, 425 POST ROAD, FAIRFIELD, CT, 06430

(21) Appl. No.: 09/313,912

(22) Filed: May 18, 1999

(30) Foreign Application Priority Data
May 26, 1998 (DE) DE 19823519

(51) Int. Cl. H01R 13/40; H01R 13/187

(52) U.S. Cl. 439/733.1; 439/931

(57) ABSTRACT

A terminal connection comprising a U-shaped spring The disclosure is of a terminal connection between a knife contact (1) and a terminal receiver (2) made of metallised plastic, the terminal receiver (2) having an opening (3) with metallised walls (3) into which a prestressed U-spring (4) is pressed and resiliently receives a knife contact (1).

The invention relates to a terminal connection according to the preamble of claim 1.

Terminal connections of this kind are used at the transition from strip conductors, e.g. on a circuit board, to connecting wires, e.g. for electromechanical components such as switches or the like. In the case of strip conductors, electroplating of plastic supporting parts has given good results for certain applications, and this technique as far as possible has been extended to the connection to other components. For example in some known terminal connections, e.g. in U.S. Pat. No. 4,973,262, a connecting wire is pressed into a terminal which tapers downwards in a wedge shape. The side walls of the terminal slot are electroplated. Such connections are unsuitable for releasable connections, since the electroplating may become worn or drop off if the connecting wire is frequently removed.

The object of the invention is to improve a terminal connection between a connecting wire and strip connectors made of metallised plastic, so as to ensure long-lasting contact at high contact pressure, high long-term stability and little wear after repeated unplugging of the connection.

This problem is solved according to the claim. The sub-claims specify preferred embodiments of the invention.

According to the invention a U-spring is pressed into the terminal receiver and resiliently presses a knife contact against a side wall of the terminal receiver. This ensures that the clamping forces are not applied via the plastic, and this advantageously influences the long-term life of the terminal connection.

The invention will now be explained in further detail by describing an exemplified embodiment with reference to the drawings, in which:

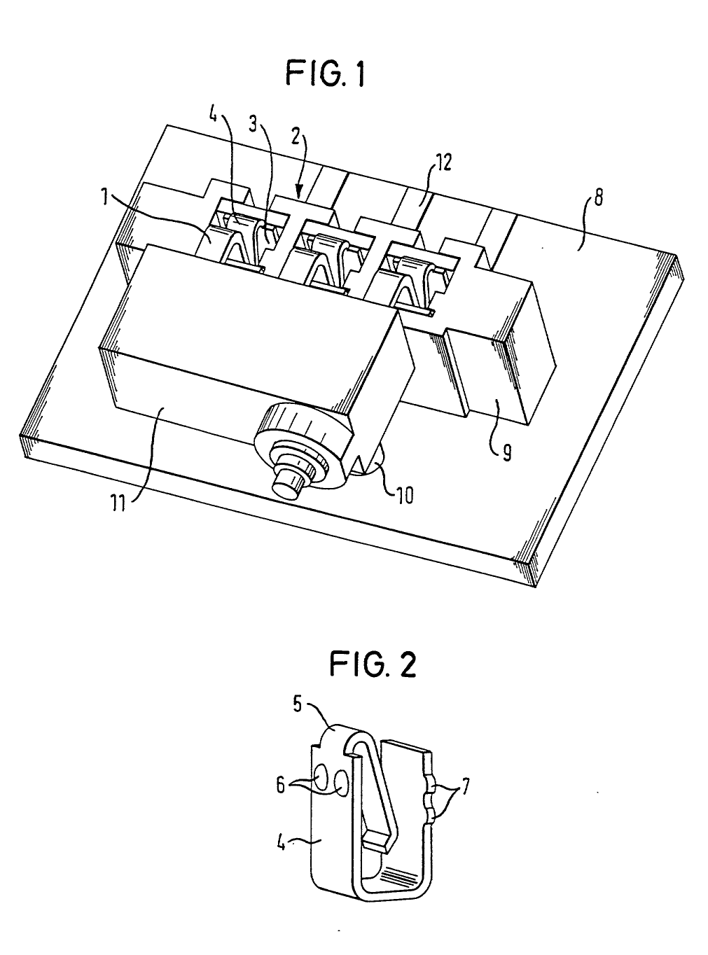

FIG. 1 is a perspective view of the terminal connection according to the invention, on a supporting part and

FIG. 2 shows the U-spring inserted into the terminal region.

FIG. 1 shows an electromechanical component 11 fastened via a holder 10 to a supporting part 8. Knife contacts 1 extend from the switch and are bent through 90° and engage in terminal holders 2. The holders are formed in a base 9, in one piece with the supporting part 8. The opening 3 has side walls which are metallised e.g. by electroplating. The metallised inner walls of the opening 3 are in conductive contact with circuit boards 12 likewise formed on the supporting part 8 by electroplating.

U-springs are pressed into the openings 3, and the base region of the U-springs rests on the bottom of the opening 3. One arm of the U-spring 4 has a somewhat narrower prolongation 5 bent at an angle into the interior of the U and slightly bent round at its end region. The prolongation presses a knife contact 1, inserted into the terminal receiver 2, against the inside of the facing arm of the U-spring 4. Contact points 6 are disposed in the end regions of the U-shaped arm on the outside thereof and project somewhat from the outer surface of the arm, so as to ensure contact with the electroplated plastic inner walls of the opening 3. The edges of the U-shaped arm are provided with serrated profiles for securely holding the U-spring 4 in the opening 3.

The contacting places are made by two-component injection moulding. The contact pressure of the U-spring on the knife contact is produced exclusively by the U-spring, so that there is no deformation of the plastic. The advantage of this is that the knife contacts can be inserted and unplugged more often without wearing out.

The preceding exemplified embodiment is for illustration only and in no way restricts the scope of protection of the invention.

1. A terminal connection between a knife contact (1) and a terminal receiver (2) made of metallised plastic, characterised in that the terminal receiver (2) has an opening (3) with metallised walls (3) into which a prestressed U-spring (4) is pressed and resiliently receives a knife contact (1).

2. A terminal connection according to claim 1, characterised in that one arm of the U-spring (4) has a narrower prolongation (5) which is bent at an angle downwards towards the base of the U (4) and which resiliently presses the knife contact (1) against the inner wall of the facing arm.

3. A terminal connection according to claim 1 or claim 2, characterised in that the arms of the U-spring (4), at their outer ends, have projecting contact points (6) and partially serrated edges (7) for engagement in the plastic receiver (2).

4. A terminal connection according to any of claims 1 to 3, characterised in that the terminal receiver (2) is disposed in a base (9) made in one piece with a supporting part (8), and a holder (10) for an e.g. electromechanical component (11) is immediately adjacent the supporting part (8), so that when the component (11) is assembled, the knife contacts (1) engage in the terminal receiver (2).

5. A terminal connection according to any of the preceding claims, characterised in that strip conductors made by two-component injection moulding extend from the terminal receiver (2) on the supporting part (8).

6. A terminal connection according to any of the preceding claims, characterised in that the electroplated plastics are LCP or PES.

7. A terminal connection according to any of the preceding claims, characterised in that the electromechanical component (11) is a switch and the supporting component (8) is a cover of a casing for an electric circuit.
